(19) United States
(12) Patent Application Publication
(10) Pub. No.: US 2025/0339940 A1
(43) Pub. Date: Nov. 6, 2025

(54) TOOL BIT ASSEMBLY INCLUDING A MAGNETISM BOOSTER

(71) Applicant: MILWAUKEE ELECTRIC TOOL CORPORATION, Brookfield, WI (US)

(72) Inventors: Katherine J. Haim, Waukesha, WI (US); James J. Van Essen, Hales Corners, WI (US); Praneeth Gandi, Pewaukee, WI (US); Zachary M. McMahon, Wauwatosa, WI (US); Matthew J. Fiddes, Milwaukee, WI (US)

(21) Appl. No.: 19/194,594

(22) Filed: Apr. 30, 2025

Related U.S. Application Data
(60) Provisional application No. 63/641,518, filed on May 2, 2024.

(51) Int. Cl. B25B 23/12; B25B 15/00

(52) U.S. Cl. CPC B25B 23/12; B25B 15/001

(57) ABSTRACT

A tool bit assembly includes a tool bit having a drive portion defining a first end of the tool bit and configured to be coupled to a tool, and a tip defining a second end of the tool bit and configured to engage a workpiece. The tool bit assembly also includes a magnetism booster having a base collar mounted to the tip of the tool bit, an outer sleeve movably received on the base collar and including a forward end, a rearward end, and a flange extending radially inward at the rearward end, a magnet positioned at the forward end of the outer sleeve, and a spring positioned between the base collar and the flange of the outer sleeve to bias the flange away from the base collar.

### CROSS-REFERENCE TO RELATED APPLICATIONS

This application claims priority to U.S. Provisional Application No. 63/641,518, filed May 2, 2024, the entire contents of which are incorporated by refence herein.

### FIELD OF THE INVENTION

The present invention relates to tool bit assemblies and, more particularly, to tool bit assemblies including magnetism boosters.

### SUMMARY

In some aspects, the techniques described herein relate to a tool bit assembly including: a tool bit including a drive portion defining a first end of the tool bit and configured to be coupled to a tool, and a tip defining a second end of the tool bit and configured to engage a workpiece; and a magnetism booster including a base collar mounted to the tip of the tool bit, an outer sleeve movably received on the base collar and including a forward end, a rearward end, and a flange extending radially inward at the rearward end, a magnet positioned at the forward end of the outer sleeve, and a spring positioned between the base collar and the flange of the outer sleeve to bias the flange away from the base collar.

In some aspects, the techniques described herein relate to a tool bit assembly, wherein the tool bit includes a shaft interconnecting the drive portion and the tip, and wherein the shaft has a smaller outer dimension than both the drive portion and the tip.

In some aspects, the techniques described herein relate to a tool bit assembly, wherein the outer sleeve is configured to translate along the base collar relative to the tip and against a bias of the spring.

In some aspects, the techniques described herein relate to a tool bit assembly, wherein the magnetism booster further includes a retainer, wherein a recess is defined on an inner surface of the base collar, wherein the recess is configured to receive and support the retainer, and wherein the retainer partially protrudes from the recess to engage the tip to inhibit the base collar from moving relative to the tip.

In some aspects, the techniques described herein relate to a tool bit assembly, wherein the magnet is secured to the outer sleeve such that the magnet is configured to move with the outer sleeve against the bias of the spring.

In some aspects, the techniques described herein relate to a tool bit assembly, wherein the magnet has an outer diameter that is greater than an inner diameter of the outer sleeve, thereby creating an interference fit between the magnet and the outer sleeve that secures the magnet relative to the outer sleeve.

In some aspects, the techniques described herein relate to a tool bit assembly, wherein the outer sleeve is configured to translate relative to the tip of the tool bit between a first operation state and a second operation state, and wherein the tip protrudes further from the forward end of the outer sleeve when the outer sleeve is in the first operation state than when the outer sleeve is in the second operation state.

In some aspects, the techniques described herein relate to a tool bit assembly, wherein the tool bit assembly is configured to engage a fastener such that a magnetic force between the magnet and the fastener overcomes a bias of the spring to move the outer sleeve from the first operation state to the second operation state.

In some aspects, the techniques described herein relate to a magnetism booster for use with a tool bit, the magnetism booster including: a base collar configured to be mounted to the tool bit; an outer sleeve movably received on the base collar and including a forward end, a rearward end, and a flange extending radially inward at the rearward end; a magnet positioned at the forward end of the outer sleeve; and a spring positioned between the base collar and the flange of the outer sleeve to bias the flange away from the base collar.

In some aspects, the techniques described herein relate to a magnetism booster, further including a retainer, wherein a recess is defined on an inner surface of the base collar, wherein the recess is configured to receive and support the retainer, and wherein the retainer partially protrudes from the recess and is configured to engage the tool bit.

In some aspects, the techniques described herein relate to a magnetism booster, wherein the retainer is a c-clip.

In some aspects, the techniques described herein relate to a magnetism booster, wherein the magnet is secured relative to the outer sleeve such that the magnet is configured to move with the outer sleeve relative to the base collar.

In some aspects, the techniques described herein relate to a magnetism booster, wherein the magnet has an annular shape that enables the tool bit to pass through a center of the magnet.

In some aspects, the techniques described herein relate to a magnetism booster, wherein the spring is a first spring, and the magnetism booster further including a second spring positioned between the base collar and the magnet.

In some aspects, the techniques described herein relate to a tool bit for use with a magnetism booster, the tool bit including: a drive portion defining a first end of the tool bit and configured to be coupled to a tool, the drive portion having a first maximum outer dimension; a shaft extending from the drive portion in a direction away from the first end of the tool bit, the shaft having a second maximum outer dimension; and a tip defining a second end of the tool bit and configured to engage a workpiece, the tip having a third maximum outer dimension, the tip including a plurality of vanes, a plurality of flutes, each flute defined between adjacent ones of the plurality of vanes, and a groove configured to receive a coupling member from the magnetism booster to couple the magnetism booster to the tool bit; wherein the groove is formed into the tip at a position forward of the shaft and rearward of the plurality of vanes.

In some aspects, the techniques described herein relate to a tool bit, wherein the second maximum outer dimension is smaller than each of the first maximum outer dimension and the third maximum outer dimension.

In some aspects, the techniques described herein relate to a tool bit, wherein the groove is closer to the shaft than to the second end of the tool bit.

In some aspects, the techniques described herein relate to a tool bit, wherein the groove is a circumferential recess that extends continuously about the tip.

In some aspects, the techniques described herein relate to a tool bit, wherein the groove is at a location of the tip where an outer dimension of the tip is greatest such that portions of the tip surrounding the groove have a thickness equal to the third maximum outer dimension.

In some aspects, the techniques described herein relate to a tool bit, wherein the second maximum outer dimension of the shaft is less than an outer dimension of the groove.

### BRIEF DESCRIPTION OF THE DRAWINGS

FIG. 1 is a perspective view of a tool bit assembly according to an embodiment of the disclosure.

FIG. 2 is an exploded view of the tool bit assembly of FIG. 1.

FIG. 3 is a side view of a tool bit of the tool bit assembly of FIG. 1.

FIG. 4A is a cross-sectional view of the tool bit assembly of FIG. 1 taken along line 4-4 and with a magnetism booster of the tool bit assembly in a first operation state.

FIG. 4B is a cross-sectional view of the tool bit assembly of FIG. 1 taken along line 4-4 and with the magnetism booster of the tool bit assembly in a second operation state.

FIG. 5A is a schematic illustration of a working operation of the tool bit assembly of FIG. 1 with the magnetism booster in the first operation state.

FIG. 5B is a schematic illustration of a working operation of the tool bit assembly of FIG. 1 with the magnetism booster in the second operation state.

FIG. 6 is a perspective view of a tool bit assembly according to another embodiment of the disclosure.

FIG. 7 is an exploded view of the tool bit assembly of FIG. 6.

FIG. 8A is a cross-sectional view of the tool bit assembly of FIG. 6 taken along line 8-8 and with a magnetism booster of the tool bit assembly in a first operation state.

FIG. 8B is a cross-sectional view of the tool bit assembly of FIG. 6 taken along line 8-8 and with the magnetism booster of the tool bit assembly in a second operation state.

FIG. 8C is a cross-sectional view of the tool bit assembly of FIG. 6 taken along line 8-8 and with the magnetism booster of the tool bit assembly in a third operation state.

FIG. 9 is a schematic illustration of a working operation of the tool bit assembly of FIG. 6 with the magnetism booster in the third operation state.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

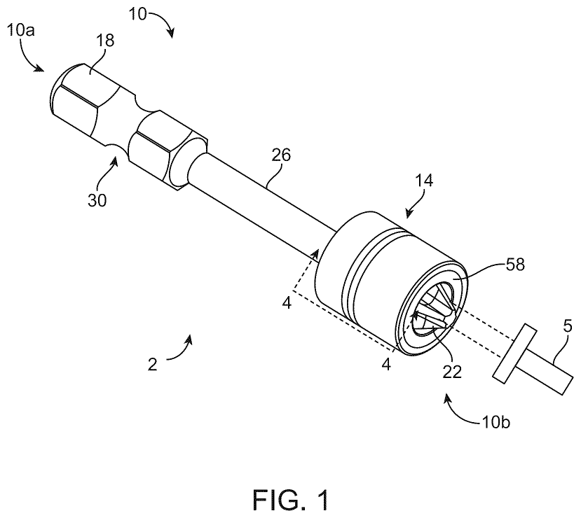

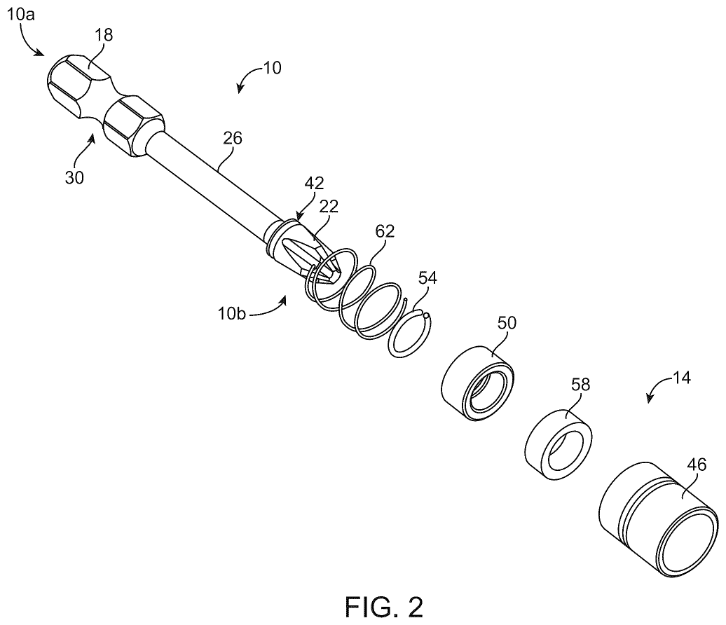

FIGS. 1 and 2 illustrate a tool bit assembly 2 including a tool bit 10 and a magnetism booster 14. The tool bit 10 is configured to drive a workpiece 5, such as a fastener (e.g., a screw, a bolt, etc.). The magnetism booster 14 is mounted on the tool bit 10 to help align and retain the fastener 5 on the tool bit 10 via magnetism. The tool bit 10 is configured to be coupled to a tool. For example, in some embodiments, the tool bit 10 is configured to be inserted into a power tool to receive torque from the power tool and apply the torque to the fastener 5. In other embodiments, the tool bit 10 may be coupled to a hand tool to receive torque from the hand tool. In still other embodiments, the tool bit 10 may be part of or integrated into the hand tool, such as a screwdriver.

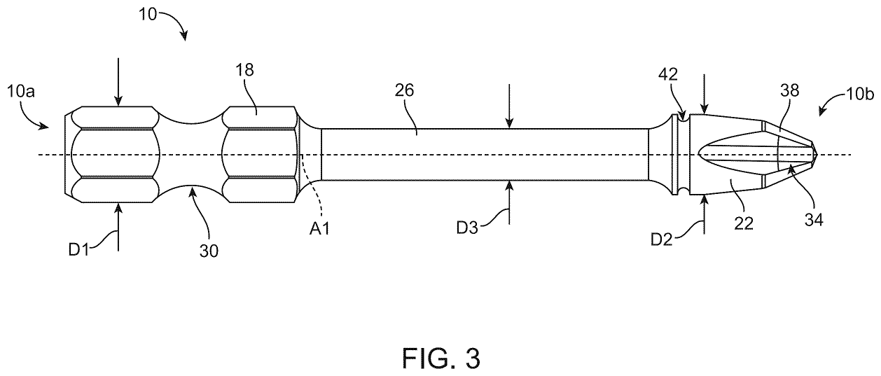

As illustrated in FIGS. 2 and 3, the illustrated tool bit 10 includes a drive portion 18, a tip 22, and a shaft 26 extending between and interconnecting the drive portion 18 and the tip 22. The drive portion 18 defines a first end 10a of the tool bit 10, and the tip 22 defines a second end 10b of the tool bit 10 opposite the drive portion 18. In the illustrated embodiment, the drive portion 18, the tip 22, and the shaft 26 are integrally formed as a single piece. For example, the drive portion 18, the tip 22, and the shaft 26 may be formed of a relatively hard material, such as steel. In other embodiments, the drive portion 18, the tip 22, and the shaft 26 may be separate pieces that are permanently or removably coupled together. In such embodiments, the drive portion 18, the tip 22, and the shaft 26 may be made of different materials or the same material. The tool bit 10 is configured to rotate about a central longitudinal axis A1 that extends through the drive portion 18, the shaft 26, and the tip 22.

The drive portion 18 is configured to be engaged by any number of different tools, adapters, or components to receive torque from the tool, adapter, or component to rotate the tool bit 10. For example, the tool bit 10 may be utilized with a driver including a socket having a corresponding recess in the which the drive portion 18 of the tool bit 10 is received. The driver may also include a stem extending from the socket, which may be coupled to a handle for hand-use by an operator or to a chuck of a power tool (e.g., a drill) for powered use by the operator. The illustrated drive portion 18 is a hexagonal drive portion 18 having a hexagonal cross-section. A drive groove 30 is defined in the hexagonal drive portion 18 and may be configured to receive a quick-release structure from the driver to secure the tool bit 10 to the driver. Alternatively, a sliding, frictional fit between the drive portion 18 of the tool bit 10 and the socket may be used to axially secure the tool bit 10 to the driver.

The drive portion 18 has a maximum outer dimension D1. The maximum outer dimensions D1 is measured perpendicular to the central longitudinal axis A1. In the illustrated embodiment, the maximum outer dimension D1 is measured between opposing corners of the hexagonal drive portion 18. In other embodiments, the maximum outer dimension D1 may be measured between other extremities of the drive portion 18, depending on the shape of the drive portion 18.

The tip 22 is formed at an end of the shaft 26 opposite from the drive portion 18. The tip 22 provides a working end or head for the tool bit 10 and is configured to engage a fastener (e.g., a screw). In the illustrated embodiment, the tip 22 is configured as a Phillips-style tip. Alternatively, the tip 22 may have other configurations to engage different styles of fasteners. For example, the tip 22 may be configured as a straight blade (otherwise known as a “regular head”) to engage fasteners having a corresponding straight slot. Other tip configurations (e.g., hexagonal, star, square, etc.) may also be employed with the tool bit 10.

The tip 22 includes a plurality of flutes, or recesses 34, circumferentially spaced around the tip 22. The illustrated flutes 34 are equidistantly disposed about the axis A1. The flutes 34 extend longitudinally along the tip 22 and converge into vanes 38. The vanes 38 are formed with flat, tapered side walls and outer walls, such that the outer walls are inclined and form the front ends of the vanes 38. The vanes 38 are also equidistantly disposed around the tip 22. In the illustrated embodiment, the vanes 38 gradually increase in thickness towards the shaft 26 to a maximum outer dimension D2 of the tip 22, which increases the strength of the tool bit 10. The maximum outer dimension D2 is measured perpendicular to the central longitudinal axis A1. The illustrated maximum outer dimension D2 of the tip 22 is generally equal to the maximum outer dimension D1 of the drive portion 18. In other embodiments, the maximum outer dimension D2 of the tip 22 may be larger or smaller than the maximum outer dimension D1 of the drive portion 18.

The tip 22 additionally includes a tip groove 42 defined between the shaft 26 and the vanes 38. In other words, the tip groove 42 is defined in the tip 22 at a location forward of the shaft 26 and rearward of the vanes 38. In the illustrated embodiment, the tip groove 42 is formed in the tip 22 at a location of the tip 22 where the outer dimension of the tip 22 is the greatest (i.e., the maximum outer dimension D2) such that each of the portions of the tip 22 surrounding the tip groove 42 have a thickness equal to the maximum outer dimension D2 of the tip 22. In other embodiments, the tip groove 42 may be formed elsewhere along the tip 22, such as in/through the vanes 38. The illustrated tip groove 42 is a circumferential recess that extends continuously about the tip 22. In other embodiments, the tip groove 42 may include one or more discrete recesses formed in the tip 22. The tip groove 42 is configured to receive a coupling feature from the magnetism booster 14 to secure the magnetism booster 14 and the tool bit 10 relative to one another, as will be described in more detail below.

With continued reference to FIGS. 2 and 3, the shaft 26 extends between the drive portion 18 and the tip 22. The illustrated shaft 26 is generally cylindrical. In other embodiments, the shaft 26 may have other shapes or configurations. For example, the shaft 26 may have a hexagonal or square cross-section, or the shape of the shaft 26 may vary along its length. The shaft 26 has a maximum outer dimension D3. The maximum outer dimension D3 is measured perpendicular to the central longitudinal axis A1. In the illustrated embodiment, the maximum outer dimension D3 is a diameter of the shaft 26. In other embodiments, the maximum outer dimension D3 may be a different dimension, depending on the shape and configuration of the shaft 26. The maximum outer dimension D3 of the shaft 26 is less than the maximum outer dimension D1 of the drive portion 18 and is less than the maximum outer dimension D2 of the tip 22. In some embodiments, the maximum outer dimension D3 of the shaft 26 is less than 75% of the maximum outer dimension D1 of the drive portion 18 and/or the maximum outer dimension D2 of the tip 22. In other embodiments, the maximum outer dimension D3 of the shaft 26 is between about 25% and about 75% of the maximum outer dimension D1 of the drive portion 18 and/or the maximum outer dimension D2 of the tip 22. In the illustrated embodiment, the maximum outer dimension D3 of the shaft 26 is about 50% of the maximum outer dimension D1 of the drive portion 18 and/or the maximum outer dimension D2 of the tip 22. In the illustrated embodiment, the maximum outer dimension D3 of the shaft 26 is less than an outer dimension of the tip groove 42. In some embodiments, the maximum outer dimension D3 of the shaft 26 is greater than an outer dimension of the trip groove 42.

The above-described tool bit 10 is only one example of a tool bit. In other embodiments, the tool bit 10 may have other configurations (e.g., shapes, sizes, parts, etc.). Alternatively, as noted above, the tool bit 10 may be part of or integrated with a tool. In such embodiments, the tool bit 10 may not include, for example, the drive portion 18.

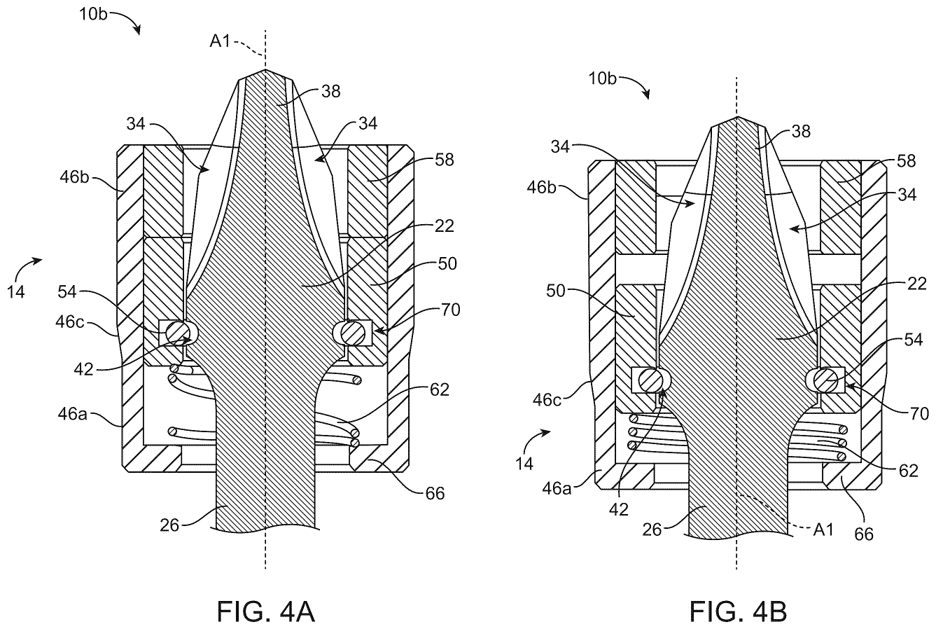

As illustrated in FIGS. 2 and 4A, the magnetism booster 14 is mounted to and surrounds the tool bit 10 at the tip 22 adjacent to the second end 10b of the tool bit 10. The illustrated magnetism booster 14 includes an outer sleeve 46, a base collar 50, a retainer 54, a magnet 58, and a spring 62. Each of the base collar 50, the retainer 54, the magnet 58, and the spring 62 is positioned within the outer sleeve 46. The outer sleeve 46 is generally cylindrical and includes a first portion 46a, a second portion 46b, and a flange 66 that extends radially inward from the first portion 46a of the outer sleeve 46 at a rearward end of the outer sleeve 46. The first portion 46a is positioned rearwardly of the second portion 46b along the central longitudinal axis A1 of the tool bit 10. The first portion 46a has a smaller diameter than the second portion 46b such that the outer sleeve 46 includes a step 46c between the first portion 46a and the second portion 46b. The step 46c may provide a surface to help a user, for example, pull the magnetism booster 14 off of the tool bit 10. In other embodiments, the first portion 46a and the second portion 46b may have the same diameter, or the first portion 46a may have a larger diameter than the second portion 46b. In the illustrated embodiment, the outer sleeve 46 is formed of an elastomeric material, such as rubber. In other embodiments, the outer sleeve 46 may be formed of another type of material. For example, the outer sleeve 46 may be a metal material. With the magnetism booster 14 in a first, or pre-engagement operation state, as illustrated in FIG. 4A, at least a portion of the tip 22 protrudes from a forward end of the outer sleeve 46 and the magnet 58 and is configured to engage a fastener, such as the fastener 5 of FIG. 1.

The base collar 50 and the retainer 54 are positioned within the outer sleeve 46 roughly at the middle of the outer sleeve 46. In the illustrated embodiment, the base collar 50 is substantially cylindrical and includes a recess 70 defined on an inner surface of the base collar 50 that receives and supports the retainer 54. The base collar 50 has an outer diameter that is less than an inner diameter of the outer sleeve 46, which may allow the base collar 50 to slide, or translate, relative to the outer sleeve 46. The retainer 54 may partially protrude from the recess 70 of the base collar 50 and into the tip groove 42 formed in the tip 22 of the tool bit 10 to secure the base collar 50 on the tool bit 10. The retainer 54 may be formed of an elastomeric material that creates, or provides, a friction fit between the base collar 50 and the tip 22 of the tool bit 10 to inhibit relative movement between the base collar 50 and the tip 22 of the tool bit 10. As such, the base collar 50 may be configured to move with the tip 22 of the tool bit 10 during a working operation of the tool bit 10. If sufficient force is applied, the retainer 54 may also deflect to allow installation or removal of the base collar 50 from the tool bit 10. In the illustrated embodiment, the retainer 54 is a c-clip. In other embodiments, the retainer 54 may be another suitable coupling member, such as an o-ring, a ball detent, and the like.

The magnet 58 is positioned at a forward end of the outer sleeve 46. In the illustrated embodiment, the magnet 58 has a ring or annular shape that enable the tip 22 to pass through a center of the magnet 58. In other embodiments, the magnet 58 may have other configurations. For example, the magnet 58 may be composed of one or more magnet pieces that are arranged in a circle (or other suitable shape) around the tip 22. An outer diameter of the illustrated magnet 58 is greater than an inner diameter of the outer sleeve 46, thereby creating an interference fit between the outer sleeve 46 and the magnet 58 that secures the magnet 58 relative to the outer sleeve 46. That is, the magnet 58 may stretch the outer sleeve 46 radially outward such that the elastomeric outer sleeve 46 applies a reactionary force on the magnet 58 that secures and inhibits movement of the magnet 58 relative to the outer sleeve 46. In other embodiments, the outer sleeve 46 may be formed of a hard or metal material such that the magnet 58 is secured to the outer sleeve 46 through a friction fit or magnetic attraction. In some embodiments, the magnet 58 may be secured to the outer sleeve 46 by a fastener and/or adhesive.

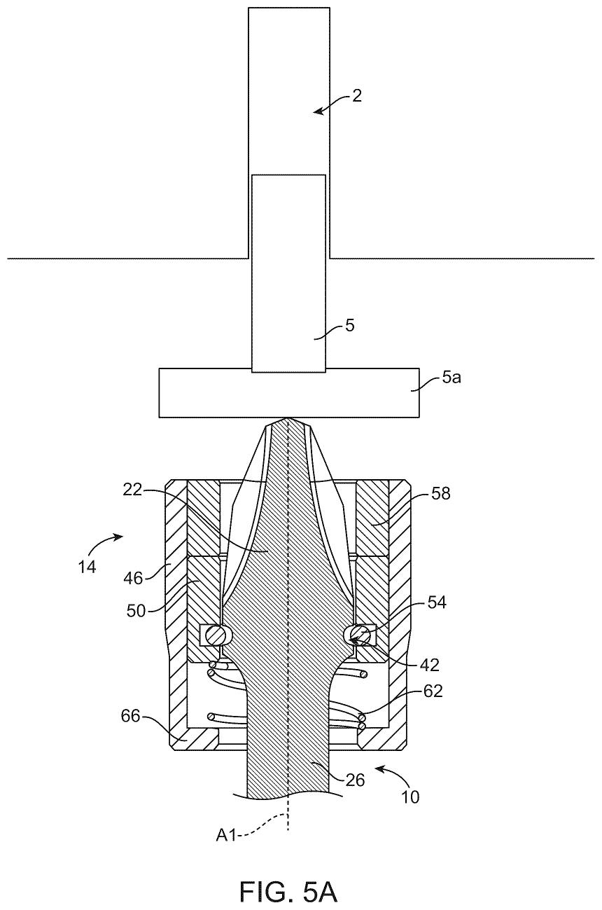

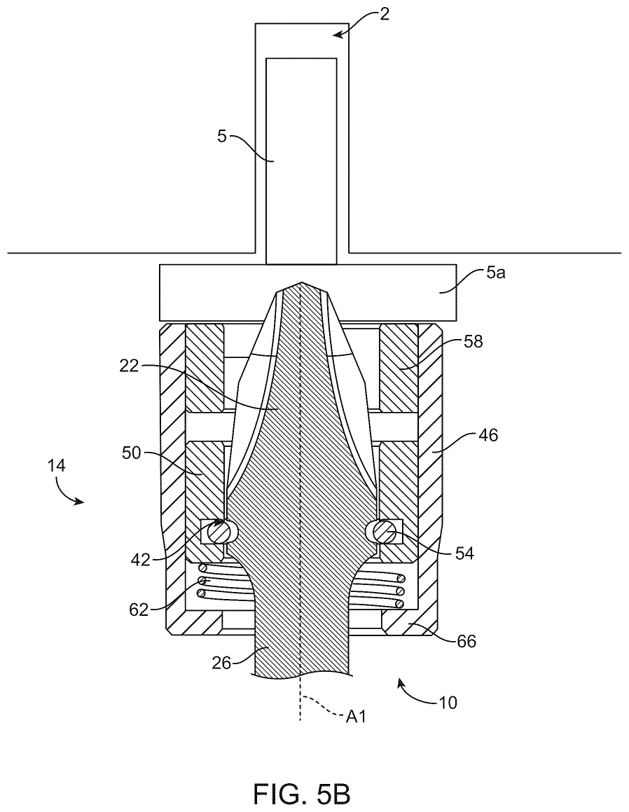

During a working operation of the tool bit 10 with the magnetism booster 14 mounted thereon, the magnet 58 is configured to help align and hold a fastener, such as the fastener 5 of FIG. 1, on the tool bit 10. Specifically, with reference to FIG. 5A, the magnet 58 creates a magnetic field that magnetically attracts the fastener. Due to the ring-shape of the illustrated magnet 58, the magnetic attraction between the magnet 58 and the fastener may align the fastener with the central longitudinal axis A1 of the tool bit 10, thereby improving the case with which the tip 22 of the tool bit 10 may engage the fastener.

With reference to FIGS. 4A and 4B, the spring 62 is positioned on a side of the base collar 50 opposite from the magnet 58. In the illustrated embodiment, the spring 62 is a coil compression spring. In other embodiments, the magnetism booster 14 may include other suitable types of springs, such as a stack of wave springs, an elastomeric member, and the like. The spring 62 is positioned between the base collar 50 and the flange 66 at the rearward end of the outer sleeve 46. The spring 62 may bias the flange 66 of the outer sleeve 46 away from the base collar 50, thereby stretching and making the outer sleeve 46 taut while the magnetism booster 14 is in the first, or pre-engagement operation state (FIG. 4A). Therefore, when the magnetism booster 14 is in the pre-engagement operation state of FIG. 4A, the illustrated spring 62 is extended. During the working operation, the outer sleeve 46 may be movable against the bias of the spring 62 to transition, or adjust, the magnetism booster 14 to a second, or engaged operation state (FIG. 4B). When the magnetism booster 14 is in the engaged operation state of FIG. 4B, the illustrated spring 62 is compressed. Due to the movement of the outer sleeve 46, the tip 22 protrudes further from the forward end of the outer sleeve 46 when the outer sleeve 46 is in the first operation state than when the outer sleeve 46 is in the second operation state.

With reference to FIGS. 5A and 5B, in operation of the tool bit 10 and the magnetism booster 14, a user may first insert the drive portion 18 of the tool bit 10 into a tool to secure the tool bit 10 relative to the tool such that the tool is able to drive rotation of the tool bit 10 about the central longitudinal axis A1. The user may then position the tip 22 of the tool bit 10 generally in alignment with a fastener 5 for driving the fastener 5 into a hole 2. In some embodiments or uses, a user may drive the fastener 5 directly into a surface which does not have a pre-existing hole 2. In such instances, the magnet 58 may improve alignment between the fastener 5 and the surface to ensure that the fastener 5 is properly driven into the surface. As the user moves the tip 22 of the tool bit 10 closer to the fastener 5, the magnet 58 in the magnetism booster 14 will assist with aligning the fastener 5 along the central longitudinal axis A1 for engagement between the tip 22 of the tool bit 10 and the fastener 5. Specifically, the magnet 58 creates a magnetic field that attracts the fastener 5, thereby aligning the fastener 5 such that a head 5a of the fastener 5 is oriented perpendicularly to the central longitudinal axis A1 of the tool bit 10. Without the magnet 58, the fastener 5 could be oriented transverse to the central longitudinal axis A1. In such situations, without adjustment from the user, the tool bit 10 may tighten the fastener 5 along a path that is improperly aligned with the hole 2. For example, if the fastener 5 is positioned such that the head 5a of the fastener 5 is oriented at a non-perpendicular angle relative to the central longitudinal axis A1, the tool bit 10 may drive the fastener 5 into a hole 2 at an improper angle and may damage the fastener 5 and/or the hole 2.

With reference to FIGS. 5A and 5B, once the tip 22 and the fastener 5 are aligned, the tip 22 may engage the fastener 5 and begin fastening (i.e., tightening) the fastener 5 within the hole 2. As the tip 22 is placed within a near-enough proximity to the fastener 5, the magnetic attraction, and more specifically, the magnetic force between the magnet 58 and the fastener 5 becomes strong enough to overcome the spring force supplied by the spring 62. Resultantly, the magnetic force between the magnet 58 and the fastener 5 will urge the flange 66 of the outer sleeve 46 against the bias of the spring 62, thereby sliding the outer sleeve 46 and the magnet 58 in a forward direction relative to the tool bit 10 and the base collar 50. As such, the magnetic force will move the outer sleeve 46 from the first operation state to the second operation state. Due to the engagement between the base collar 50, the retainer 54, and the tip groove 42, the base collar 50 does not translate with the outer sleeve 46. Rather, the outer sleeve 46 may slide along an outer surface of the base collar 50 as the magnet 58 effectively pulls the outer sleeve 46 against the bias of the spring 62. Once the working operation (e.g., a tightening operation) is complete, a user may pull the power tool, and thus the tool bit 10 and the magnetism booster 14, away from the fastener 5 with a force to overcome the magnetic force between the magnet 58 and the fastener 5. With the magnet 58 separated from the fastener 5, the spring 62 may bias the flange 66 of the outer sleeve 46 away from the base collar 50 to return the magnetism booster 14 to the pre-engagement operation state, as illustrated in FIG. 4A.

The tool bit 10 and the magnetism booster 14 may also be used in a similar manner to remove the fastener 5 from the hole 2. In such a scenario, the magnet 58 may help temporarily hold the fastener 5 such that the fastener 5 does not drop off the tool bit 10 and become lost as the fastener 5 is removed from the hole 2.

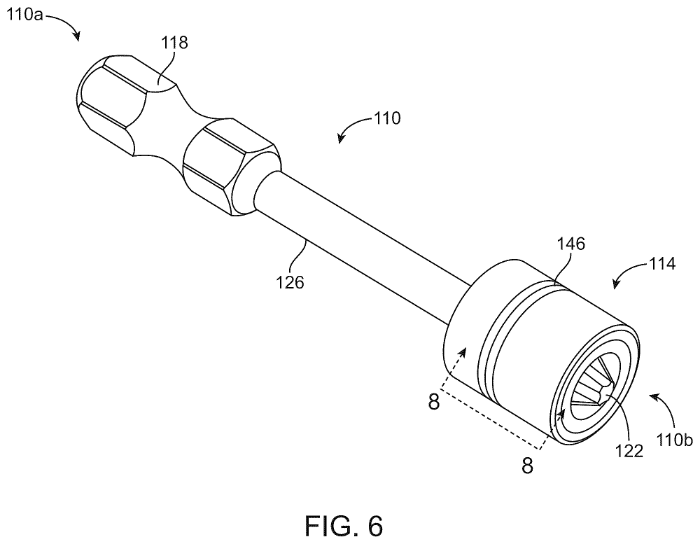

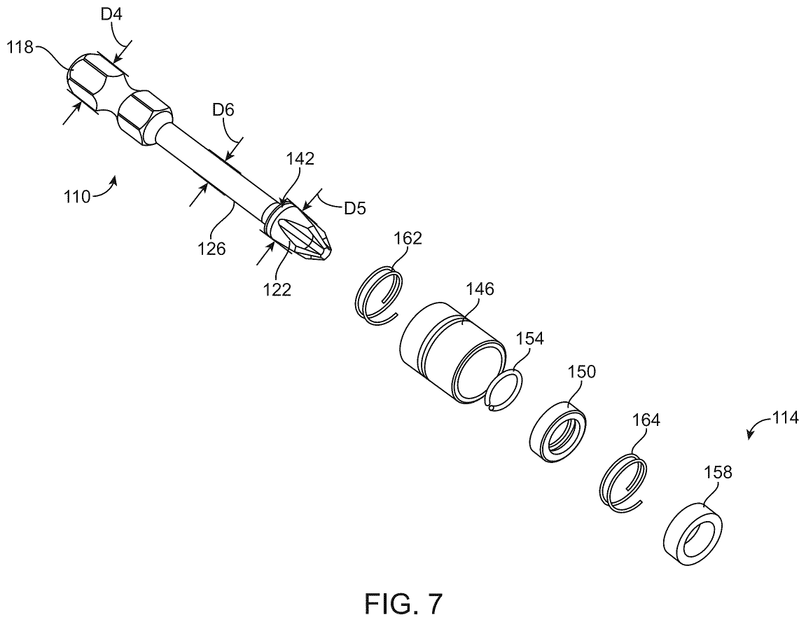

FIGS. 6 and 7 illustrate a tool bit assembly according to another embodiment of the disclosure. The tool bit assembly of FIGS. 6 and 7 may be substantially similar to the tool bit assembly of FIGS. 1-3, except for the differences described herein.

In the illustrated embodiment of FIGS. 6 and 7, the tool bit assembly includes a tool bit 110 and a magnetism booster 114. The tool bit 110 includes a drive portion 118 that defines a first end 110a of the tool bit 110 and has a maximum outer dimension D4, a tip 122 that defines a second end 110b of the tool bit 110 and has a maximum outer dimension D5, and a shaft 126 that extends between and interconnects the drive portion 118 and the tip 122. A tip groove 142 is defined in the tip 122 at a location forward of the shaft 126. The shaft 126 has a maximum outer dimension D6. Each of the drive portion 118, the tip 122, the shaft 126, and the tip groove 142 may be substantially similar, and in some embodiments, identical, to a corresponding one of the drive portion 18, the tip 22, the shaft 26, and the tip groove 42 of the tool bit 10 of FIG. 2.

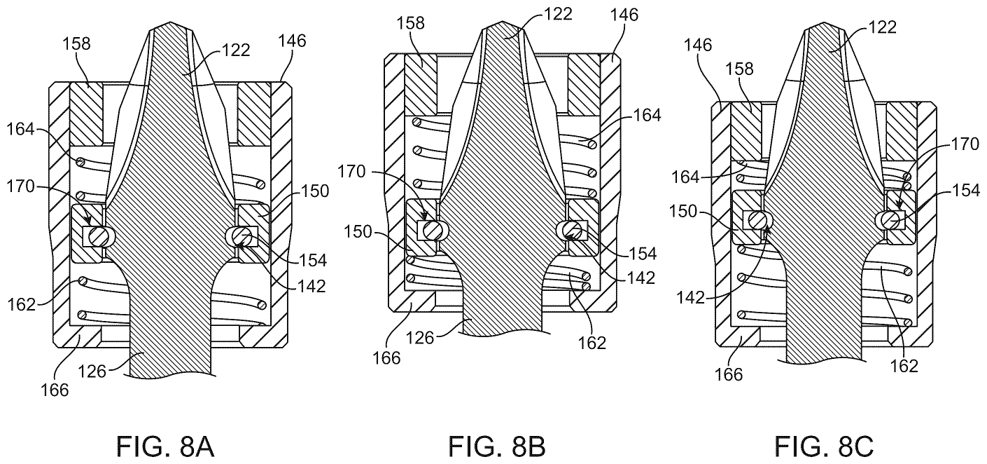

The magnetism booster 114 is mounted to and surrounds the tool bit 110 at the tip 122 adjacent to the second end 110b of the tool bit 110. The illustrated magnetism booster 114 includes an outer sleeve 146, a base collar 150, a retainer 154, a magnet 158 supported within the outer sleeve 146 at a forward end of the outer sleeve 146, a first spring 162, and a second spring 164. Each of the outer sleeve 146, the base collar 150, the retainer 154, and the magnet 158 is substantially similar to a corresponding one of outer sleeve 146, the base collar 150, the retainer 154, and the magnet 158 of FIG. 2. As shown in FIGS. 8A-8C, the outer sleeve 146 includes a flange 166 that extends radially inward from a portion of the outer sleeve 146 at a rearward end of the outer sleeve 146. The base collar 150 and the retainer 154 are positioned within the outer sleeve 146. The base collar 150 includes a recess 170 that receives and supports the retainer 154. The retainer 154 may partially protrude from the recess 170 of the base collar 150 and into the tip groove 142 formed in the tip 122 of the tool bit 110 to secure the base collar 150 on the tool bit 110.

In the illustrated embodiment, the base collar 150 is relatively smaller than the base collar 50 of FIG. 4A to accommodate the first spring 162 and the second spring 164 within the outer sleeve 146. The first spring 162 is positioned on a side of the base collar 150 opposite from the magnet 158. That is, the first spring 162 is positioned between the base collar 150 and the flange 166 and may bias the flange 166 of the outer sleeve 146 away from the base collar 150. The second spring 164 is positioned on a side of the base collar 150 opposite from the flange 166. That is, the second spring 164 is positioned between the base collar 150 and the magnet 158 and may bias the magnet 158 away from the base collar 150.

The first spring 162 and the second spring 164 enable the magnetism booster 114 to shift between a first operation state, a second operation state, and a third operation state. The first operation state may also be referred to as a pre-engagement operation state. With reference to FIG. 8A, in the first operation state, the first spring 162 and the second spring 164 apply equal and opposite (i.e., directionally opposite) forces on the base collar 150 such that the spring forces may effectively balance each other and leave no residual bias within the magnetism booster 114. The first operation state may be substantially similar to the pre-engagement state described with respect to the tool bit 10 and the magnetism booster 14 of FIG. 4A. Specifically, the tip 122 of the tool bit 110 in FIG. 8A protrudes from the outer sleeve 146 by the same distance as the tip 22 of the tool bit 10 in FIG. 4A (relative to the forward end of the outer sleeve 46 of FIG. 4A) when the magnetism boosters 14, 114 are in the pre-engagement operation state. During the working operation, with reference to FIGS. 8B and 8C, the outer sleeve 146 may be movable against the bias of the first spring 162 to transition, or adjust, the magnetism booster 114 to the second operation state (FIG. 8B), and the outer sleeve 146 may be movable against the bias of the second spring 164 to transition, or adjust, the magnetism booster 114 to the third state (FIG. 8C). The second operation state may also be referred to as an engaged operation state. The second operation state may be substantially similar to the engaged operation state described with respect to the tool bit 10 and the magnetism booster 14 of FIG. 4B.

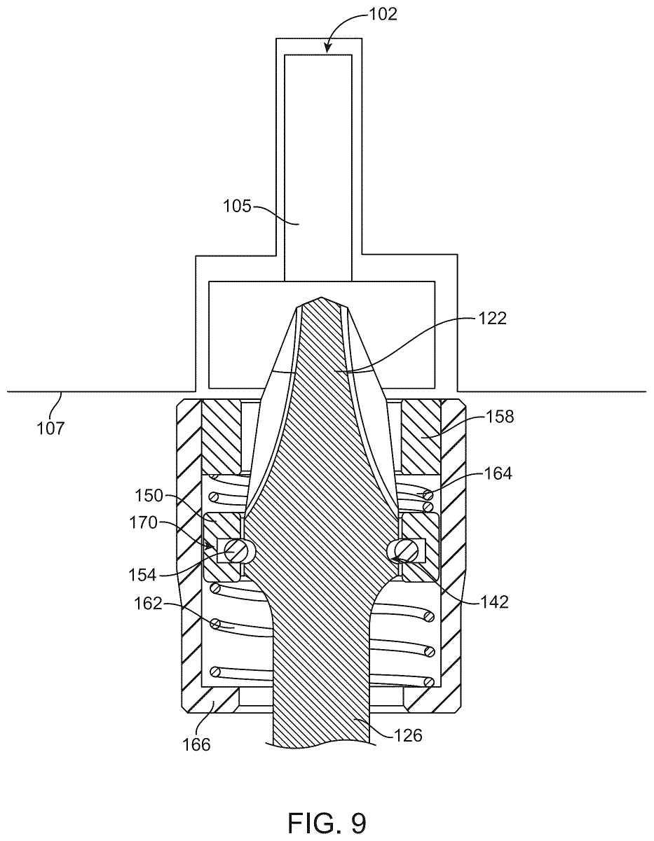

With reference to FIGS. 8C and 9, the third operation state may also be referred to as a sub-flush engaged operation state. To move to the third operation state, the outer sleeve 146 and the magnet 158 move rearwardly (i.e., relative to the tip 122 and the base collar 150) and compress the second spring 164 between the base collar 150 and the magnet 158. In the third operation state, due to the rearward movement of the outer sleeve 146 and the magnet 158, the tip 122 protrudes from a forward end of the outer sleeve 146 and the magnet 158 by a larger distance than in the first operation state and the second operation state. The third operation state thus correlates to a working operation in which the tip 122 may extend beneath a surface 107 (i.e., sub-flush) to drive a fastener 105 into a hole 102, or in some instances, directly into the surface 107, during a working operation. The second spring 164 advantageously enables the tool bit 110 to drive the fastener 105 sub-flush into the surface 107 in the third operation state without the magnetism booster 114 being forced off of the tip 122 and onto the shaft 126 during the rearward movement of the outer sleeve 146 and the magnet 158. Once the working operation is complete, the second spring 164 may bias the magnet 158 and the outer sleeve 146 forward to return the magnetism booster 114 to the first operation state.

Although the invention is described with reference to discrete embodiments of the tool bit assembly, variations of the tool bit assembly exist within the spirit and scope of the invention. Various features and advantages of the invention are set forth in the following claims.

1. A tool bit assembly comprising:
a tool bit including
a drive portion defining a first end of the tool bit and configured to be coupled to a tool, and
a tip defining a second end of the tool bit and configured to engage a workpiece; and
a magnetism booster including
a base collar mounted to the tip of the tool bit,
an outer sleeve movably received on the base collar and including a forward end, a rearward end, and a flange extending radially inward at the rearward end,
a magnet positioned at the forward end of the outer sleeve, and
a spring positioned between the base collar and the flange of the outer sleeve to bias the flange away from the base collar.

2. The tool bit assembly of claim 1, wherein the tool bit includes a shaft interconnecting the drive portion and the tip, and wherein the shaft has a smaller outer dimension than both the drive portion and the tip.

3. The tool bit assembly of claim 1, wherein the outer sleeve is configured to translate along the base collar relative to the tip and against a bias of the spring.

4. The tool bit assembly of claim 3, wherein the magnetism booster further includes a retainer, wherein a recess is defined on an inner surface of the base collar, wherein the recess is configured to receive and support the retainer, and wherein the retainer partially protrudes from the recess to engage the tip to inhibit the base collar from moving relative to the tip.

5. The tool bit assembly of claim 3, wherein the magnet is secured to the outer sleeve such that the magnet is configured to move with the outer sleeve against the bias of the spring.

6. The tool bit assembly of claim 5, wherein the magnet has an outer diameter that is greater than an inner diameter of the outer sleeve, thereby creating an interference fit between the magnet and the outer sleeve that secures the magnet relative to the outer sleeve.

7. The tool bit assembly of claim 1, wherein the outer sleeve is configured to translate relative to the tip of the tool bit between a first operation state and a second operation state, and wherein the tip protrudes further from the forward end of the outer sleeve when the outer sleeve is in the first operation state than when the outer sleeve is in the second operation state.

8. The tool bit assembly of claim 7, wherein the tool bit assembly is configured to engage a fastener such that a magnetic force between the magnet and the fastener overcomes a bias of the spring to move the outer sleeve from the first operation state to the second operation state.

9. A magnetism booster for use with a tool bit, the magnetism booster comprising:
a base collar configured to be mounted to the tool bit;
an outer sleeve movably received on the base collar and including a forward end, a rearward end, and a flange extending radially inward at the rearward end;
a magnet positioned at the forward end of the outer sleeve; and
a spring positioned between the base collar and the flange of the outer sleeve to bias the flange away from the base collar.

10. The magnetism booster of claim 9, further comprising a retainer, wherein a recess is defined on an inner surface of the base collar, wherein the recess is configured to receive and support the retainer, and wherein the retainer partially protrudes from the recess and is configured to engage the tool bit.

11. The magnetism booster of claim 10, wherein the retainer is a c-clip.

12. The magnetism booster of claim 9, wherein the magnet is secured relative to the outer sleeve such that the magnet is configured to move with the outer sleeve relative to the base collar.

13. The magnetism booster of claim 9, wherein the magnet has an annular shape that enables the tool bit to pass through a center of the magnet.

14. The magnetism booster of claim 9, wherein the spring is a first spring, and the magnetism booster further comprising a second spring positioned between the base collar and the magnet.

15. A tool bit for use with a magnetism booster, the tool bit comprising:
a drive portion defining a first end of the tool bit and configured to be coupled to a tool, the drive portion having a first maximum outer dimension;
a shaft extending from the drive portion in a direction away from the first end of the tool bit, the shaft having a second maximum outer dimension; and
a tip defining a second end of the tool bit and configured to engage a workpiece, the tip having a third maximum outer dimension, the tip including
a plurality of vanes,
a plurality of flutes, each flute defined between adjacent ones of the plurality of vanes, and
a groove configured to receive a coupling member from the magnetism booster to couple the magnetism booster to the tool bit;
wherein the groove is formed into the tip at a position forward of the shaft and rearward of the plurality of vanes.

16. The tool bit of claim 15, wherein the second maximum outer dimension is smaller than each of the first maximum outer dimension and the third maximum outer dimension.

17. The tool bit of claim 15, wherein the groove is closer to the shaft than to the second end of the tool bit.

18. The tool bit of claim 15, wherein the groove is a circumferential recess that extends continuously about the tip.

19. The tool bit of claim 15, wherein the groove is at a location of the tip where an outer dimension of the tip is greatest such that portions of the tip surrounding the groove have a thickness equal to the third maximum outer dimension.

20. The tool bit of claim 15, wherein the second maximum outer dimension of the shaft is less than an outer dimension of the groove.
